(19) United States
(12) Patent Application Publication
(10) Pub. No.: US 2021/0366306 A1
(43) Pub. Date: Nov. 25, 2021

(54) ATLAS/NOTE FINDER MUSIC THEORY APPLICATION

(71) Applicant: Ronald P. Marciano, Chicago, IL (US)

(72) Inventor: Ronald P. Marciano, Chicago, IL (US)

(21) Appl. No.: 16/881,303

(22) Filed: May 22, 2020

(51) Int. Cl. G09B 15/02; G10G 1/02; G09B 5/02

(52) U.S. Cl. CPC G09B 15/023; G09B 15/003; G09B 5/02; G10G 1/02

(57) ABSTRACT

A system and method for providing music teaching tools, and more specifically, a system and method for providing a color-coded music theory and guitar note teacher is disclosed. The system includes a note finder fret board for guitar, a domino editor for creating a visual representation of a sequence of musical notes using the note finder fret board, the domino editor manipulates a color-coded domino for each musical note in the sequence of musical notes, a music staff reader for transforming a sequence of musical notes represented in a music staff representation into the visual representation of a sequence of musical notes using the note finder fret board, and a music staff generator for transforming a sequence of musical notes represented in the visual representation of a sequence of musical notes using the note finder fret board a music staff representation into the music staff representation. The note finder fret board for guitar is a color-coded fret board representation having a one of a plurality of color codes assigned for each guitar string at each fret on a guitar, the each of the plurality of color codes correspond to musical note on a musical scale, a color coded set of color-coded dominos corresponding to a set of musical scales associated with each musical key.

### TECHNICAL FIELD

This application relates in general to a system and method for providing music teaching tools, and more specifically, to a system and method for providing a color-coded music theory and guitar note teacher.

### BACKGROUND

The guitar is an interesting instrument. It's like several guitars in one. You can play one note at a time. You can play two notes at a time (dyads). And you can play three or more notes at a time (chords). You can pick and solo or play rhythms by strumming. In any case it's a lot of fun once you get started. On the guitar there are six strings and 24 frets. There are about 144 places to play a note. Each string contains two copies of a given note from the chromatic scale; one held within the first twelve frets and another below it. No current teaching system or application addresses these abilities.

Therefore, a need exists for a for providing a color-coded music theory and guitar note teacher.

### SUMMARY

In accordance with the present invention, the above and other problems are solved by providing a system and method for providing a color-coded music theory and guitar note teacher according to the principles and example embodiments disclosed herein.

In one embodiment, the present invention is a system for providing a color-coded music theory and guitar note teacher. Finding notes on the Note Finder™ fret board is easy because of the color scheme created for this musical system. The color scheme makes learning music theory easier than traditional methods alone. It can facilitate all aspects of music theory and can be used in the field of education by creating drag and drop lessons and tests. Students can easily transition from the Atlas?/Note Finder teacher to traditional formats of music theory. The Note Finder™ system provides a quick and easy format for playing guitar by incorporating a visual presentation of music. There are three learning styles that exist in education: audio, kinesthetic (hands-on), and visual styles. The Note Finder™ system addresses all of these learning styles. Using an Atlas™ scale generator and the Note Finder™ fret board in unison makes learning music theory and guitar simultaneously fun and easy.

In another embodiment, the present invention is a method for providing a color-coded music theory and guitar note teacher. The method creates a sequence of musical note to be played on a guitar, displays the sequence of musical notes in a note finder fret board for guitar corresponding to a sequence of musical cords from a first musical key, transforms a representation of a musical cord from the first musical key to a second musical key by substituting a first color code corresponding to a first note of the musical cord from a first scale corresponding to the first musical key into a second color code corresponding to the first note of the musical cord from a second scale corresponding to the second musical key, displays the sequence of musical notes in a note finder fret board for guitar corresponding to a sequence of musical cords from the second musical key. The note finder fret board comprises a color-coded fret board representation having a one of a plurality of color codes assigned for each guitar string at each fret on a guitar, the each of the plurality of color codes correspond to musical note on a musical scale, and a color coded set of color-coded dominos corresponding to a set of musical scales associated with each musical key.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIGS. 1a-c illustrate an example embodiment for a system that provides a color-coded music theory and guitar note teacher according to the present invention.

FIG. 2 illustrates an example embodiment of a user application for providing a color-coded music theory and guitar note teacher according to the present invention.

FIGS. 3a-b illustrate an example embodiment of a music staff as presented by a Note Finder™ system according to the present invention.

FIG. 4 illustrates a music education assignment and music creation using a Note Finder™ system with software components according to the present invention.

FIGS. 5a-b illustrate teaching chord progression using the Note Finder™ system according to the present invention

FIG. 6 illustrates a Note Finder™ guitar fret board according to the present invention.

FIG. 7 illustrates a computing system of software components providing a Note Finder™ music teaching system according to the present invention.

FIG. 8 illustrates a flowchart corresponding to a method performed by software components providing a Note Finder™ music teaching system according to the present invention.

FIG. 9 illustrates a generalized schematic of a programmable processing system utilized as the various computing components described herein to implement an embodiment of the present invention.

### DETAILED DESCRIPTION

This application relates in general to a system and method for providing music teaching tools, and more specifically, to a system and method for providing a color-coded music theory and guitar note teacher according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The terms “student,” and “user” refer to an entity, e.g. a human, using the Note Finder™ music teacher including any software or smart device application(s) associated with the invention. The term user herein refers to one or more users.

The term “invention” or “present invention” refers to the invention being applied for via the patent application with the title “Note Finder™ Music Teaching System.” Invention may be used interchangeably with Note Finder™ system and teaching system.

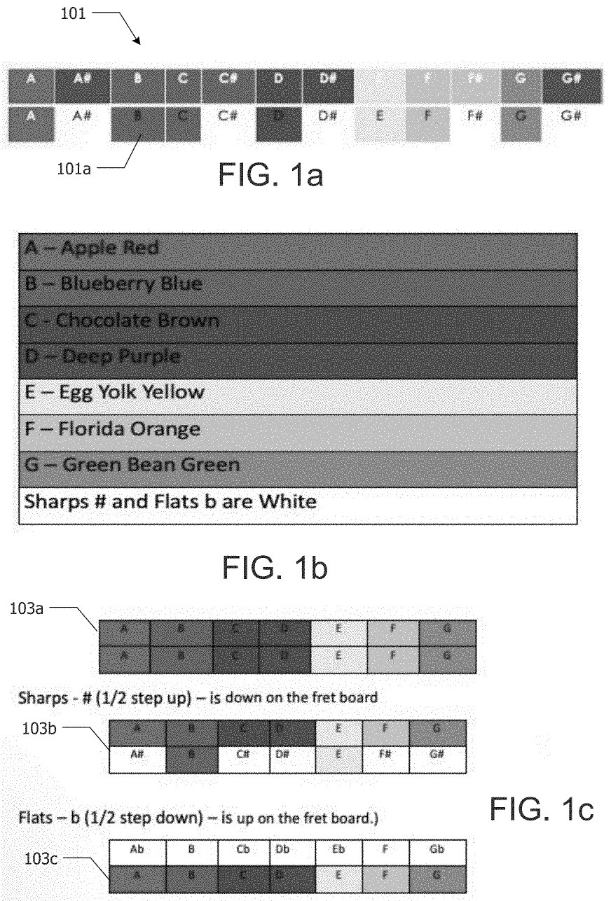

In general, the present disclosure relates to a system and method for providing a guitar music teaching system. To better understand the present invention, FIGS. 1a-c illustrate an example embodiment for a system that provides a color-coded music theory and guitar note teacher according to the present invention. FIG. 1a shows a Note Finder™ color-coded chromatic scale. The color coded scale 101 consists of a note domino I Ola containing two notes for each step through the scale. These note dominos I O1a present notes to be played by a student while learning scales, chords, music, and the like. The note dominos I Ola may be arranged in any order to represent a sequence of notes corresponding to the scale or song. The note domino I Ola is the basic building block of the Note Finder™ music teacher.

FIG. 1b illustrates a color key used in the Note Finder™ music teacher. Each of the colors represents a different note, A through G, that defines an octave of notes. The color code utilized in a preferred embodiment is as follows:

A—Apple Red

B—Blueberry Blue

C—Chocolate Brown

D—Deep Purple

E—Egg Yolk Yellow

F—Florida Orange

G—Green Bean Green

Sharp and Flat notes are shown in the Note Finder™ music teacher using the color white. The above color code is used throughout the Note Finder™ music teacher.

FIG. 1e illustrates the various color-coded note dominoes I O1a used for all notes, including sharp and flat variations on a base note. The first set of note dominoes I O3a represents the base notes. The second set of note dominos I O3b represents sharp notes, which are ½ step up from its base note. The third set of note dominos I O3c represents flat notes, which are ½ step down from its base note. Using all of these note dominos 103a-c, any scale and piece of music may be represented within the Note Finder™ music teacher.

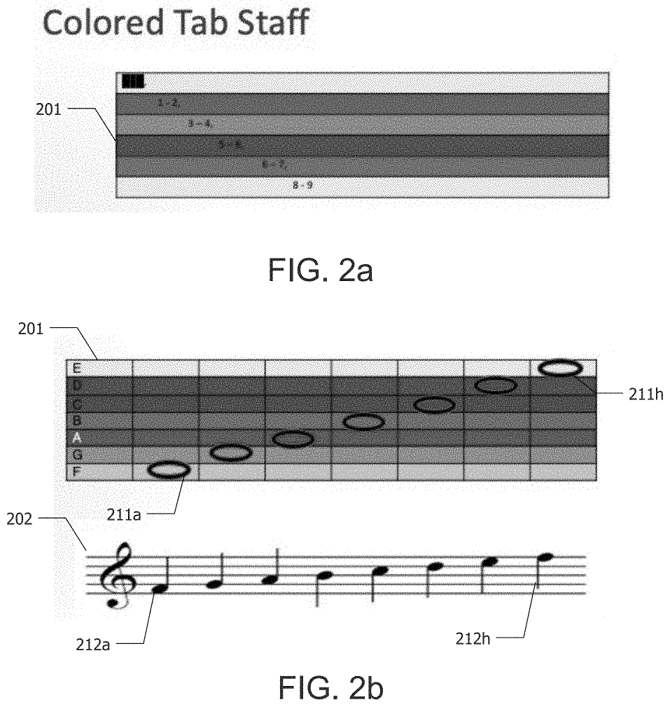

FIGS. 2a-b illustrate an example embodiment of a music staff as presented by a Note Finder™ teacher according to the present invention. A basic music staff presents seven lines onto which an octave of notes may be presented. FIG. 2a illustrates this basic music staff using the color code of the Note Finder™ music teacher 201. FIG. 2b in contrast illustrates a simple scale represented in the color code of the Note Finder™ music teacher 211 and in a standard music staff 212. Each note in the scale 212a-h shown on the standard staff212 corresponds to the note circle 211a-h in the Note Finder™ music staff 211. This comparison of the scale shown in each music staff illustrates how any scale or piece of music may be transformed from one staff to the other.

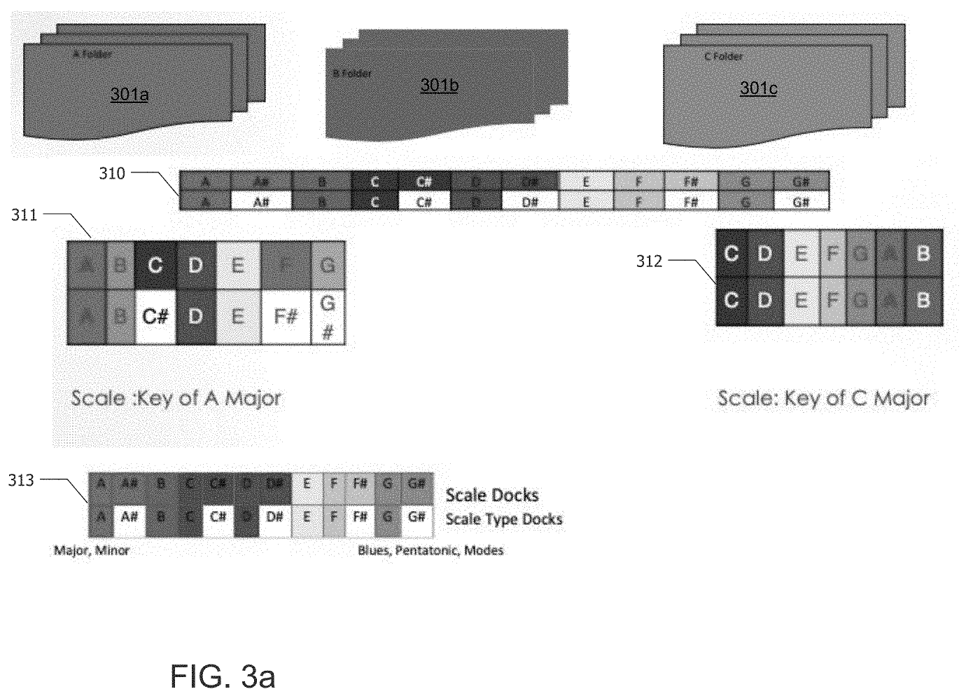

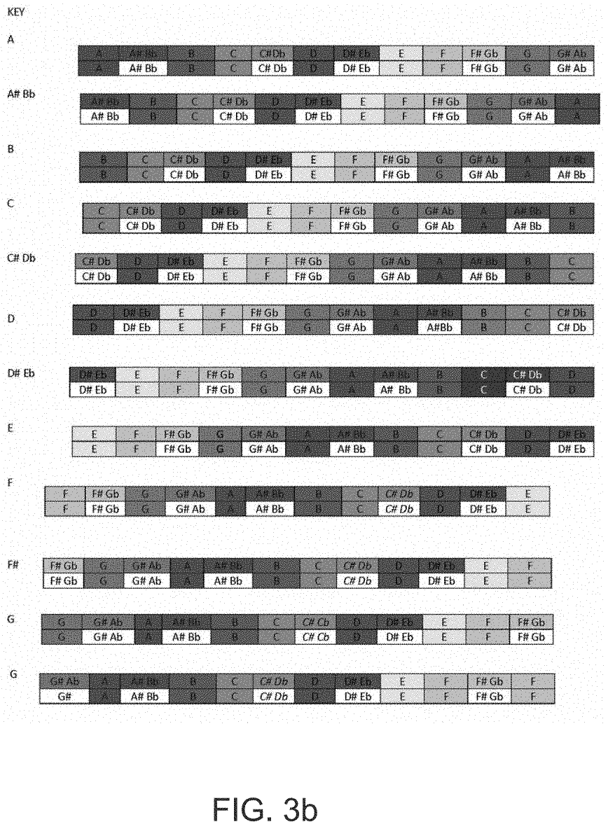

FIG. 3a illustrates an example embodiment of a user application for providing a color-coded music theory and guitar note teacher according to the present invention. An application I 00 running on a computing device, such as a personal computer, smartphone, tablet, or cloud computer using a web browser, allows teachers and students to utilize the Note Finder™ music teacher to create and use teaching exercises for learning how to play a guitar. The application 100 uses color-coded folders 301a-c to hold.

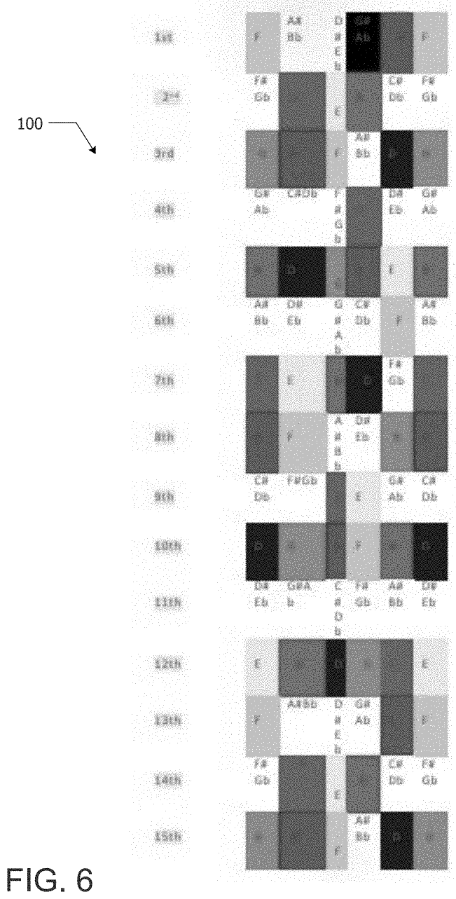

Using drag and drop technology, the color-coded chromatic scale palette 310, and the color-coded fret board, the Note Finder™ music teacher 100 allows the student and teacher to graphically display and create scales, chords, chord inversions, dyads, and 144 notes. A teacher may begin by defining an exercise with a scale from a particular key of music. Scales for the key of A Major 311 and the key of C Major 312 are shown. Using note dominos 313 a, the teacher may arrange a series of note dominos 313 to represent a sequence of notes to be practiced and learned by the student. The Note Finder™ music teacher may be used to assist the student in identifying these notes on a guitar by looking at a Note Finder™ fret board in order to learn how to practice the scale or other music. The Note Finder™ fret board is described below in additional detail in reference to FIG. 6.

Every lesson will have a copy of the Canvas Maker. The tools used will be determined by the learning objective of the lesson plan. The Canvas Maker uses tools determined by lesson concept. The Canvas Maker also includes: Chromatic Scale Palette, Receiving Dock1, Receiving Dock 2 (If applicable), Sub-Dock1 (If applicable), Sub-Dock 2 (If applicable), Color Scheme Palette (If Applicable), Note Finder Fret Board/Fret Locations (e.g. Creating Chords, Creating Chord Inversions, Creating Dyads), Blank Fret Board with locations, and Chip Box: NF Fret board with locations. Also included Algorithm-Rhythm Selector, both Major (WWHWWWH) and Minor (WHWWHWW), Sub-Algorithm-Rhythm Selector, both 1-IV-V (Major) and i-iv-v (minor), and Button box (red and blue buttons—e.g. Shapes).

The Canvas Maker has a student library. These student library includes Completed Assignments and Once an assignment is complete it can be used in following lessons. The assignments may be manipulated using a drag and drop process. The student library also includes chromatic scale, major scales, minor scales, blues scales, pentatonic scales, other scales, chords, chord progressions, circle of fifths, chord inversions, Dyads, Modes, Shapes, and a

Reference Library that is set to be a set of read only examples of lessons.

The system permits an instructor to create a set of lesson plans. An example of one such lesson plan includes:

FIG. 3b illustrates an Adjusted Chromatic Scales Library for Different Keys according to the present invention. The Adjusted Chromatic scale chart can be used for creating the assignments in each key library. Scales all follow the same sequences and sub-sequences. Chords all follow the same chord equations, but vary in key. Every concept in music theory can be visually reproduced using this design. For every one exercises created in the system there are twelve, one for each key. One in each library, “Student folder.” If you create ten exercises, there will be one hundred twenty. There is a lot of repetition in this program. Music theory is a structured hierarchy.

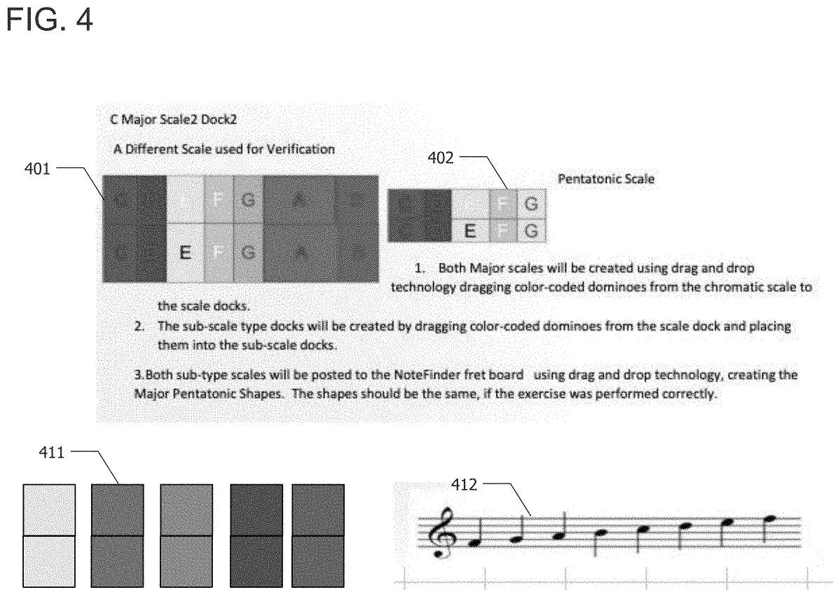

FIG. 4 illustrates a music education assignment and music creation using a Note Finder™ teacher with software components according to the present invention. In this example, a different scale may be generated as verification of learning by the student. A major scale 401 may be generated by a student using a drag and drop process of selecting and arranging a series of note dominos 313a from the color-coded chromatic scale palette 310 to represent the scale. A second subscale 402 representing pentatonic scale for the major scale 401 is created by the student using a similar drag and drop process of selecting and placing note dominos 313a into the subscale 402. The Note Finder™ application 100 will post both the major scale 401 and the pentatonic scale 402 to the Note Finder™ fret board for the student to use when practicing. The process of creating sequences of notes using note dominos 313a may be created using any set of notes from a scale or song. The Note Finder™ application 100 may show the sequence in color-coded form 411 or in a standard music staff 412 to help a student learn music represented in a standard form and associate it with the Note Finder™ form. The student also learns the note locations on the fret board.

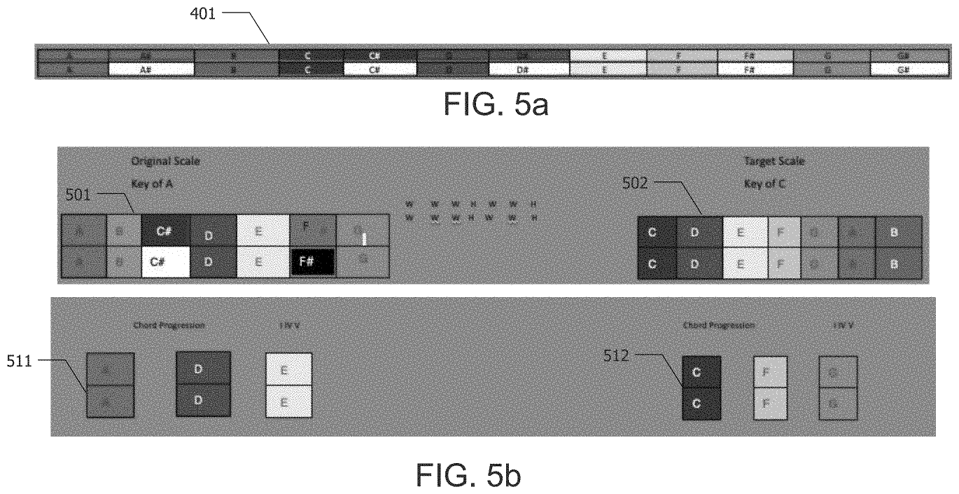

FIGS. 5a-b illustrate teaching chord progression using the Note Finder™ teacher according to the present invention. A student may learn chord progressions by creating an original scale 501 and then a target scale 502 using the drag and drop process described above. Now using these scales, a student creates a first chord 511 by identifying the notes in the chord to correspond to the I, IV, and V notes in the scale. The student may take this progression of notes I, IV, and V to the target scale 502 to identify the same chord in this different key. The second chord sequence 512 thus corresponds to C-F-G. Transposing chords from one key to another may be practiced using the Note Finder™ music teacher using this process.

FIG. 6 illustrates a Note Finder™ guitar fret board according to the present invention. The Note Finder™ fret board 601 allows a student to explore and configure dyads, also known as two note chords, triads or three note chords, and their inversions to produce musical tones. Locating the root notes of scales, modes, and riffs is made easy because the color of these notes are easily identified. It explains the “Why?” behind the shapes and patterns associated with the guitar in a visual format.

The Note Finder™ music teacher 100 provides a means of learning music theory and learning to play guitar simultaneously in a more efficient method than the traditional approaches used in the past. The color-coded system is appealing to students of all ages and is fun and easy to use.

The Note Finder™ fret board 601 consists of 6 columns of data 602a-f corresponding to the strings of a guitar. The Note Finder™ fret board 601 also consists of 24 rows of data 603a-x for each of the frets of the guitar. The student may locate the notes of any chord 511 by finding the notes having the same color on the Note Finder™ fret board 601. This fret board applies to all sequences of notes represented in the Note Finder™ music teacher 100.

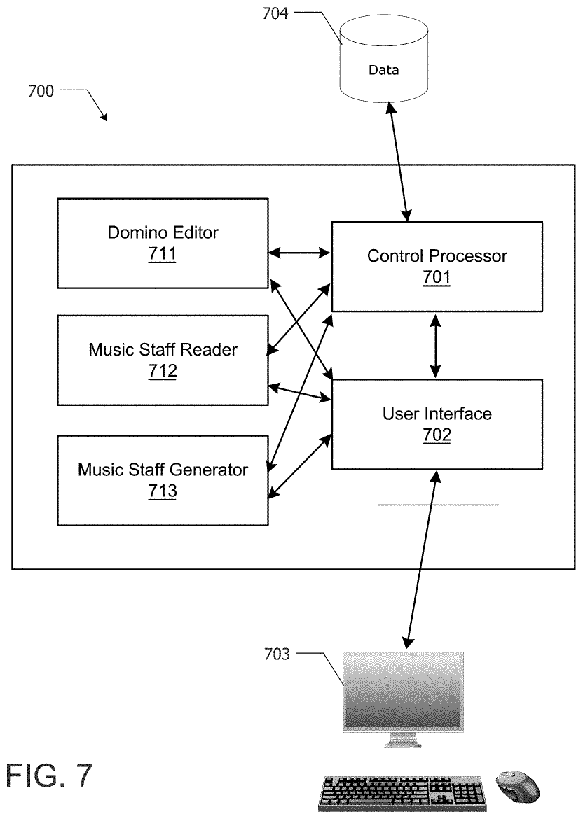

FIG. 7 illustrates a computing system of software components providing a Note Finder™ music teacher according to the present invention. The Note Finder™ music teacher 100 may be implemented on a general purpose computing device as a collection of processing components. The Note Finder™ application 700 consists of a control processor 701, a user interface 702, a data store 704, a domino editor 711, a music staff reader 712, and a music staff generator 713. The user interacts with the Note Finder™ application via a display, keyboard, and mouse combination 703 in the embodiment of FIG. 7. In other embodiments, such as the application 700 executing on a device such as a tablet, the display and input combination 703 may be a touch display screen or similar device.

The control processor 701 performs all of the logical operations needed to input commands from the user via the user interface 702, forward the user commands to an appropriate processor, receives responsive data from processors, and maintains user data stored on the data store 704. In a typical embodiment, this control processor may be an embedded programmable processing device that executes firmware stored within local memory.

The user interface 702 connects the display and input combination 703 to the application 700 and communicates with the type of display and input devices being used. The user interface processes incoming commands from users with a mouse click, a keyboard stroke, or a touch screen action, and converts the command into a form understood by the control processor 701 and the related Note Finder™ data processors.

The data store 704 provides a permanent data storage device onto which the application 700 may store user data, retrieve a library of lesson examples, and maintain software and related application data used when the application is in use. The data store 704 may be an attached storage disk, an internal solid state storage device or a remote storage location on a web server reached via the Internet (not shown).

The domino editor 711 processes user commands to manipulate note dominos 313a when a user is generating a scale, a chord progression, and other sequences of notes as disclosed herein. The domino editor 711 provides a drag and drop process of manipulating the note dominos 313a both graphically as presented to the user via the user interface and internally as data saved, used, and retrieved by the application 100. The domino editor 711 presents the color-coded chromatic scale palette 310 and the note dominos contained therein for a user to select and arrange as desired. The domino editor 711 may also maintain data structures to hold the sequence of notes created by the user so they can be stored onto the data store 704 for later use as well as be provided to the music staff reader 712 and the music staff generator 713 as the user interacts with the sequence of notes in various supported formats.

The music staff reader 712 may accept a sequence of notes represented as a standard music staff 202 and allow the user to manipulate the data represented in the Note Finder™ representation. The music staff reader 712 along with the music staff generator 713 may confirm whether a user has created an accurate representation of a scale or song in either of the supported formats. Both of these components are capable of rendering the scale or song onto a Note Finder™ fret board for use by students learning the guitar.

The music staff generator 713 acts as a companion data processor to the music staff reader 712 to translate music represented using the Note Finder™ representation into a standard music staff Both of these components are capable of rendering the scale or song onto a Note Finder™ fret board for use by students learning the guitar.

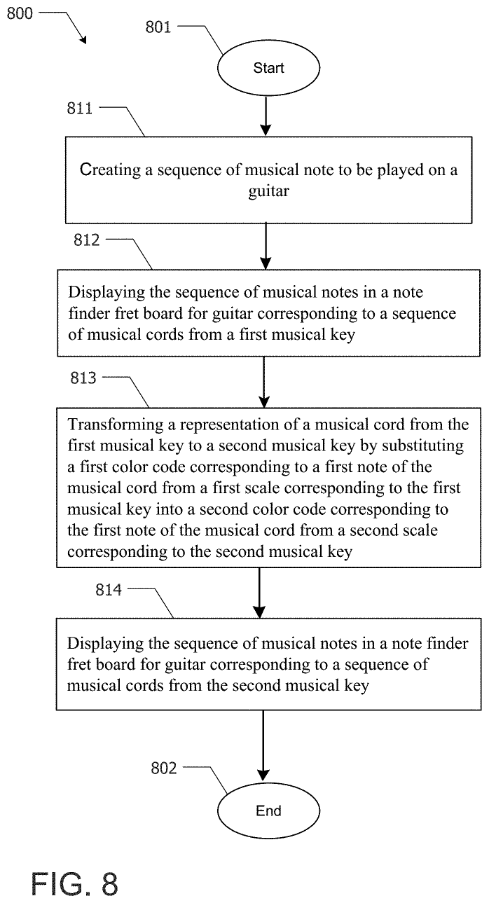

FIG. 8 illustrates a flowchart corresponding to a method performed by software components providing a Note Finder™ music teacher according to the present invention. The method 800 begins 801 when step 811 create a sequence of musical note to be played on a guitar.

Next, step 812 displays the sequence of musical notes in a note finder fret board for guitar corresponding to a sequence of musical cords from a first musical key. A representation of a musical cord is transformed in step 813 from the first musical key to a second musical key by substituting a first color code corresponding to a first note of the musical cord from a first scale corresponding to the first musical key into a second color code corresponding to the first note of the musical cord from a second scale corresponding to the second musical key. The sequence of musical notes in a note finder fret board for guitar corresponding to a sequence of musical cords is displayed in the second musical key in step 814 and the process ends 802.

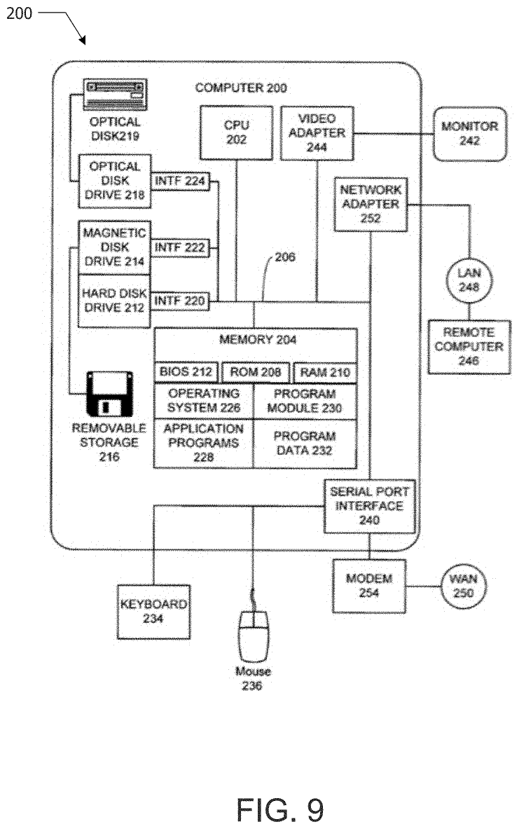

FIG. 9 illustrates a generalized schematic of a programmable processing system utilized as the various computing components described herein to implement an embodiment of the present invention. The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth™ network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and/or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of the computer system 200. Rather, the computer system 200 is provided as an example of one type of computing device that may be adapted to perform the functions of a Note Finder™ guitar music teacher, including servers, personal computers, and mobile devices as shown in FIG. 7. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated circuits (VLSI), or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps where the additional, unrecited elements or steps do not have the one or more specified characteristics.

What is claimed:

1. A system for providing music teaching tools, and more specifically, a system for providing a color-coded music theory and guitar note teacher, the system comprising:
a note finder fret board for guitar;
a domino editor for creating a visual representation of a sequence of musical notes using the note finder fret board, the domino editor manipulates a color-coded domino for each musical note in the sequence of musical notes;
a music staff reader for transforming a sequence of musical notes represented in a music staff representation into the visual representation of a sequence of musical notes using the note finder fret board; and
a music staff generator for transforming a sequence of musical notes represented in the visual representation of a sequence of musical notes using the note finder fret board a music staff representation into the music staff representation;
wherein the note finder fret board for guitar comprises:
a color-coded fret board representation having a one of a plurality of color codes assigned for each guitar string at each fret on a guitar;
the each of the plurality of color codes correspond to musical note on a musical scale; and
a color coded set of color-coded dominos corresponding to a set of musical scales associated with each musical key.

2. The system according to claim 1, wherein the plurality of color codes comprise:
a musical note of A corresponds to red;
a musical note of B corresponds to blue;
a musical note of C corresponds to brown;
a musical note of D corresponds to purple;
a musical note of E corresponds to yellow;
a musical note of F corresponds to orange; and
a musical note of G corresponds to green.

3. The system according to claim 2, wherein the plurality of color codes further comprises:
musical sharp # notes and flat b notes correspond to white.

4. The system according to claim 1, wherein the color coded set of color-coded dominos corresponding to a set of musical scales corresponding to major key scales and minor key scales.

5. The system according to claim 4, wherein the domino editor further transforms a representation of a musical cord from a first musical key to a second musical key by substituting a first color code corresponding to a first note of the musical cord from a first scale corresponding to the first musical key into a second color code corresponding to the first note of the musical cord from a second scale corresponding to the second musical key.

6. A method for providing music teaching tools, and more specifically, a method for providing a color-coded music theory and guitar note teacher, the method comprising:
creating a sequence of musical note to be played on a guitar;
displaying the sequence of musical notes in a note finder fret board for guitar corresponding to a sequence of musical cords from a first musical key;
transforming a representation of a musical cord from the first musical key to a second musical key by substituting a first color code corresponding to a first note of the musical cord from a first scale corresponding to the first musical key into a second color code corresponding to the first note of the musical cord from a second scale corresponding to the second musical key; and
displaying the sequence of musical notes in a note finder fret board for guitar corresponding to a sequence of musical cords from the second musical key;
wherein the note finder fret board comprises:
a color-coded fret board representation having a one of a plurality of color codes assigned for each guitar string at each fret on a guitar;
the each of the plurality of color codes correspond to musical note on a musical scale; and
a color coded set of color-coded dominos corresponding to a set of musical scales associated with each musical key.

7. The method according to claim 6, wherein the method further comprises:
transforming a sequence of musical notes represented in a music staff representation into the visual representation of a sequence of musical notes using the note finder fret board.

8. The method according to claim 7, wherein the method further comprises:
transforming a sequence of musical notes represented in the visual representation of a sequence of musical notes using the note finder fret board a music staff representation into the music staff representation.

9. The system according to claim 6, wherein the plurality of color codes comprise:
a musical note of A corresponds to red;
a musical note of B corresponds to blue;
a musical note of C corresponds to brown;
a musical note of D corresponds to purple;
a musical note of E corresponds to yellow;
a musical note of F corresponds to orange; and
a musical note of G corresponds to green.

10. The system according to claim 9, wherein the plurality of color codes further comprises:
musical sharp # notes and flat b notes correspond to white.
